(19) United States
(12) Patent Application Publication
(10) Pub. No.: US 2011/0153309 A1
(43) Pub. Date: Jun. 23, 2011

(54) AUTOMATIC INTERPRETATION APPARATUS AND METHOD USING UTTERANCE SIMILARITY MEASURE

(75) Inventors: Jeong Se KIM, Daejeon (KR); Sang Hun KIM, Daejeon (KR); Seung YUN, Daejeon (KR); Chang Hyun KIM, Daejeon (KR)

(73) Assignee: Electronics and Telecommunications Research Institute, Daejeon (KR)

(21) Appl. No.: 12/969,017

(22) Filed: Dec. 15, 2010

(30) Foreign Application Priority Data
Dec. 21, 2009 (KR) 10-2009-0127709

(51) Int. Cl. G06F 17/28

(52) U.S. Cl. 704/2

(57) ABSTRACT

Provided is an automatic interpretation apparatus including a voice recognizing unit, a language processing unit, a similarity calculating unit, a sentence translating unit, and a voice synthesizing unit. The voice recognizing unit receives a first-language voice and generates a first-language sentence through a voice recognition operation. The language processing unit extracts elements included in the first-language sentence. The similarity calculating unit compares the extracted elements with elements included in a translated sentence stored in a translated sentence database and calculates the similarity between the first-language sentence and the translated sentence on the basis of the comparison result. The sentence translating unit translates the first-language sentence into a second-language sentence with reference to the translated sentence database according to the calculated similarity. The voice synthesizing unit detects voice data corresponding to the second-language sentence and synthesizes the detected voice data to output an analog voice signal corresponding to the second-language sentence.

### CROSS-REFERENCE TO RELATED APPLICATIONS

This application claims priority under 35 U.S.C. §119 to Korean Patent Application No. 10-2009-0127709, filed on Dec. 21, 2009, in the Korean Intellectual Property Office, the disclosure of which is incorporated herein by reference in its entirety.

### TECHNICAL FIELD

The following disclosure relates to an automatic interpretation apparatus and method, and in particular, to an automatic interpretation apparatus and method using an inter-sentence utterance similarity measure.

### BACKGROUND

According to the related art, automatic interpretation devices may fail to perform correct sentence translation in the event of erroneous voice recognition. Also, there may be an error in translation even in the event of errorless voice recognition. Thus, if translated sentences are converted into voice signals prior to output, there may be an error in interpretation. In order to overcome these limitations, related art techniques convert voice recognition results into sentences within a limited range, translate the sentences, and convert the translated sentences into voice signals prior to output. However, if a desired sentence of a user is not within the limited range, sentence translation is limited, thus degrading the interpretation performance.

### SUMMARY

In one general aspect, an automatic interpretation apparatus includes: a voice recognizing unit receiving a first-language voice and generating a first-language sentence through a voice recognition operation; a language processing unit extracting elements included in the first-language sentence; a similarity calculating unit comparing the extracted elements with elements included in a translated sentence stored in a translated sentence database and calculating the similarity between the first-language sentence and the translated sentence on the basis of the comparison result; a sentence translating unit translating the first-language sentence into a second-language sentence with reference to the translated sentence database according to the calculated similarity; and a voice synthesizing unit detecting voice data corresponding to the second-language sentence and synthesizing the detected voice data to output an analog voice signal corresponding to the second-language sentence.

In another general aspect, an automatic interpretation method includes: receiving a first-language voice and generating a first-language sentence through a voice recognition operation; extracting elements included in the first-language sentence; comparing the extracted elements with elements included in a translated sentence stored in a translated sentence database and calculating the similarity between the first-language sentence and the translated sentence on the basis of the comparison result; receiving the first-language sentence according to the calculated similarity and translating the first-language sentence into a second-language sentence with reference to the translated sentence database; and detecting voice data corresponding to the second-language sentence and synthesizing the detected voice data to output an analog voice signal corresponding to the second-language sentence.

Other features and aspects will be apparent from the following detailed description, the drawings, and the claims.

### BRIEF DESCRIPTION OF THE DRAWINGS

FIG. 1 is a block diagram of an automatic interpretation apparatus according to an exemplary embodiment.

FIG. 2 is a flow chart illustrating an automatic interpretation method using the automatic interpretation apparatus illustrated in FIG. 1.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

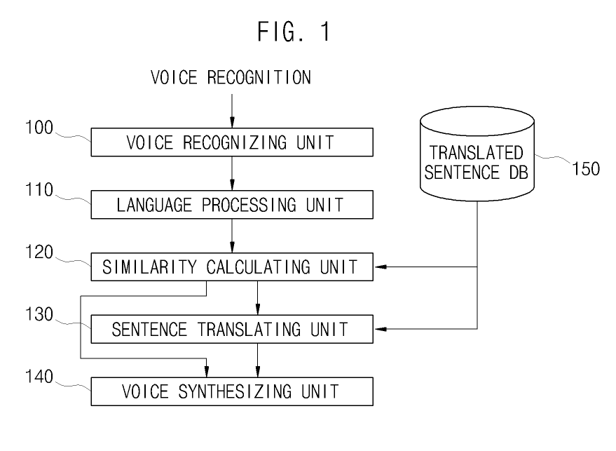

FIG. 1 is a block diagram of an automatic interpretation apparatus according to an exemplary embodiment.

Referring to FIG. 1, an automatic interpretation apparatus according to an exemplary embodiment may be applicable to various apparatuses that perform an interpretation from first language to second language. The automatic interpretation apparatus according to an exemplary embodiment recognizes user's voices and determines the similarity between the recognition results and translated sentences including pairs of prepared first-language sentences and second-language sentences. The automatic interpretation apparatus uses the determination result to output sentences desired by the user. Accordingly, sentences desired by the user can be displayed to the user even without the use of a complex translator.

Also, even when the user speaks only keywords, the automatic interpretation apparatus can display an example sentence thereof by using the translated sentences containing the keywords.

Also, when user character input is available, the automatic interpretation apparatus inputs interpretation-target sentences or keywords not only through voice recognition but also through an input unit (e.g., a keypad) to display a list of the most similar candidate sentences (among the translated sentences) on a display screen, thereby enabling the user to select a desired sentence among the displayed sentences.

The automatic interpretation apparatus includes the following units to perform the above-described operations.

The automatic interpretation apparatus includes a voice recognizing unit 100, a language processing unit 110, a similarity calculating unit 120, a sentence translating unit 130, a voice synthesizing unit 140, and a translated sentence database (DB) 150.

The voice recognizing unit 100 receives a first-language voice from the user and converts the first-language voice into a first-language sentence through a voice recognition operation. Also, the voice recognizing unit 100 outputs a confidence score for each word of the first-language sentence. The outputted confidence score may be used by the similarity calculating unit 120. Herein, the confidence score means the matching rate between the first-language voice and the first-language sentence. The automatic interpretation apparatus according to an exemplary embodiment may receive a first-language sentence (instead of the first-language voice) through a character input unit such as a keypad. In this case, the voice recognizing unit 100 may be omitted from the automatic interpretation apparatus.

The language processing unit 110 receives the first-language sentence from the voice recognizing unit 100 and extracts various elements for similarity calculation from the first-language sentence. In the case of the Korean language, the various elements include word, word segmentation, morpheme/speech part, sentence pattern, tense, affirmation/negation, modality information, and speech act representing the flow of conversation. The language processing unit 110 extracts higher semantic information (class information) together with respect to words such as person name, place name, money amount, date, and numeral. Also, the language processing unit 110 may also extract similar words similar to the word and hetero-form words for the word, through the hetero-form extension and the extension of similar words. Examples of the similar words include [symbol] (Korean)’ and [symbol] (Korean)’ that are different words with similar meanings. Examples of the hetero-form words include adopted words such as [symbol] (Korean)’ and [symbol] (Korean)’ that have different forms but have the same meaning.

The similarity calculating unit 120 considers the confidence score for each word processed by the voice recognizing unit 100 and compares the various elements extracted by the language processing unit 110 with various elements stored in the translated sentence DB 150 to calculate the similarity therebetween. Herein, the similarity calculation operation is performed by a similarity calculation algorithm expressed as Equation (1).

$$Sim ( {S}_{1} {S}_{2} ) = {\sum }_{i} {w}_{i} {f}_{i} ( {e}_{1 , i} {e}_{2 , i} ) \qquad ( 1 )$$

where S₁ denotes an input sentence, S₂ denotes a candidate sentence, fᵢ(e_{1,i}) denotes the i^{th} element of the input sentence, fᵢ(e_{2,i}) denotes a similarity function for the i^{th} element of the candidate sentence, and wᵢ denotes a weight for fᵢ.

The similarity calculation result by Equation (1) is expressed in the form of probability. A threshold value is set and it is determined whether the calculated similarity is higher than the threshold value. If the calculated similarity is higher than the threshold value, class information of the second-language sentence corresponding to the first-language sentence selected from the translated sentence DB 150 is translated and the translated result is transferred to the voice synthesizing unit 140 without passing through the sentence translating unit 130. On the other hand, if the calculated similarity is lower than the threshold value, user selection is requested or the first-language sentence (i.e., the voice recognition result) is transferred to the sentence translating unit 130. The translated sentence DB 150 includes pairs of first-language sentences and second-language sentences. For example, when the first-language sentence is [symbol] 2 [symbol] (Korean)’, the second-language sentence is ‘2 tickets to Seoul, please (English)’.

If the calculated similarity is lower than the threshold value, the sentence translating unit 130 receives the first-language sentence through the similarity calculating unit 120 and translates the first-language sentence with reference to the translated sentence DB 150. The translation result is transferred as a second-language sentence to the voice synthesizing unit 140.

The voice synthesizing unit 140 receives the second-language sentence from the similarity calculating unit 120 or the second-language sentence from the sentence translating unit 130, synthesizes the prestored voice data mapping to the received second-language sentence, and outputs the synthesized voice data in the form of analog signals.

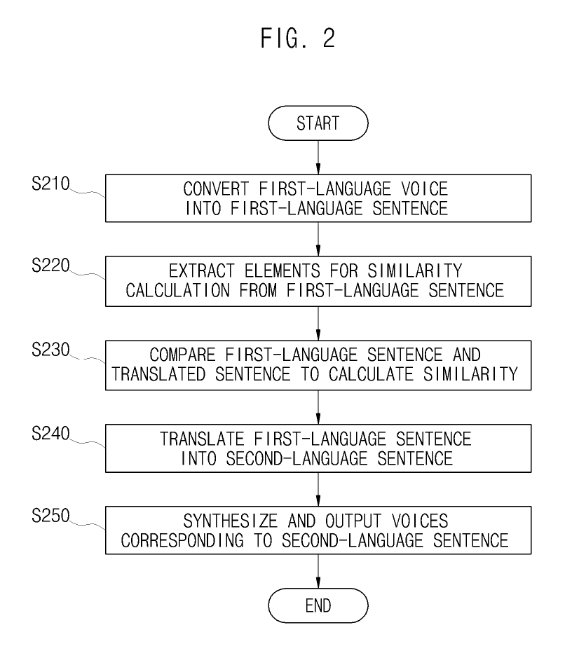

FIG. 2 is a flow chart illustrating an automatic interpretation method using the automatic interpretation apparatus illustrated in FIG. 1.

Referring to FIGS. 1 and 2, the voice recognizing unit 100 converts a first-language voice, inputted from a user, into a first-language sentence through a voice recognition operation (S210). A confidence score for each word included in the first-language sentence is generated together with the first-language sentence. The confidence score is used by the similarity calculating unit 120.

In an exemplary embodiment, an operation of selecting a voice recognition region by the user may be added before the conversion of the first-language voice into the first-language sentence (i.e., before the user voice recognition). For example, if user voice recognition is performed in an airplane or a hotel, an operation of selecting a region of an airplane or a hotel may be added. Thus, the success rate of voice recognition can be increased because a voice recognition operation is performed within the category of the region. If the user does not select a voice recognition region, an operation of classifying the region for the voice recognition result may be added.

Thereafter, the language processing unit 110 extracts elements for similarity calculation from the first-language sentence (S220). In the case of the Korean language, the extracted elements include word, word segmentation, morpheme/speech part, sentence pattern, tense, affirmation/negation, modality information, and speech act representing the flow of conversation.

Thereafter, the similarity calculating unit 120 performs a similarity calculation operation. The similarity calculation operation makes it possible to minimize a conversion error that may occur during the conversion of the first-language voice into the first-language sentence through the voice recognition operation.

For example, the similarity calculating unit 120 compares the elements extracted by the language processing unit 110 with elements included in pairs of first-language sentences and second-language sentences stored in the translated sentence DB 150 to calculate the similarity therebetween. Herein, the similarity is calculated by Equation (1). If the calculated similarity is higher than the threshold value, class information of the second-language sentence corresponding to the first-language sentence selected from the translated sentence DB 150 is translated. On the other hand, if the calculated similarity is lower than the threshold value, user selection is requested or the first-language sentence is translated (e.g., machine-translated) (S240).

Thereafter, voice data corresponding to the second-language sentence are searched and the searched voice data are synthesized to output analog voice signals (S250).

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An automatic interpretation apparatus comprising:
a voice recognizing unit receiving a first-language voice and generating a first-language sentence through a voice recognition operation;
a language processing unit extracting elements included in the first-language sentence;
a similarity calculating unit comparing the extracted elements with elements included in a translated sentence stored in a translated sentence database and calculating the similarity between the first-language sentence and the translated sentence on the basis of the comparison result;
a sentence translating unit translating the first-language sentence into a second-language sentence with reference to the translated sentence database according to the calculated similarity; and
a voice synthesizing unit detecting voice data corresponding to the second-language sentence and synthesizing the detected voice data to output an analog voice signal corresponding to the second-language sentence.

2. The automatic interpretation apparatus of claim 1, wherein the voice recognizing unit calculates a confidence score representing a word-to-word mapping rate between the first-language voice and the first-language sentence.

3. The automatic interpretation apparatus of claim 2, wherein the language processing unit extracts word, word segmentation, morpheme, speech part, sentence pattern, tense, affirmation, negation, modality information, speech act representing the flow of conversation, a word similar to the word, and a hetero-form word for the word as the elements.

4. The automatic interpretation apparatus of claim 3, wherein the similarity calculating unit uses the confidence score to calculate the similarity between the extracted elements and the elements included in the translated sentence.

5. The automatic interpretation apparatus of claim 1, wherein if the calculated similarity is higher than a predetermined threshold value, the similarity calculating unit translates the first-language sentence into the second-language sentence with reference to the translated sentence database and transfers the second-language sentence to the voice synthesizing unit without passing the second-language sentence through the sentence translating unit.

6. The automatic interpretation apparatus of claim 1, wherein if the calculated similarity is lower than a predetermined threshold value, the sentence translating unit receives the first-language sentence through the similarity calculating unit and translates the first-language sentence into the second-language sentence with reference to the translated sentence database.

7. An automatic interpretation method comprising:
receiving a first-language voice and generating a first-language sentence through a voice recognition operation;
extracting elements included in the first-language sentence;
comparing the extracted elements with elements included in a translated sentence stored in a translated sentence database and calculating the similarity between the first-language sentence and the translated sentence on the basis of the comparison result;
receiving the first-language sentence according to the calculated similarity and translating the first-language sentence into a second-language sentence with reference to the translated sentence database; and
detecting voice data corresponding to the second-language sentence and synthesizing the detected voice data to output an analog voice signal corresponding to the second-language sentence.

8. The automatic interpretation method of claim 7, wherein the generating of the first-language sentence comprises calculating a confidence score representing a word-to-word mapping rate between the first-language voice and the first-language sentence.

9. The automatic interpretation method of claim 8, wherein the calculating of the similarity comprises using the confidence score to calculate the similarity between the extracted elements and the elements included in the translated sentence.

10. The automatic interpretation method of claim 7, wherein the elements include word, word segmentation, morpheme, speech part, sentence pattern, tense, affirmation, negation, modality information, speech act representing the flow of conversation, a word similar to the word, and a hetero-form word for the word.

11. The automatic interpretation method of claim 7, wherein the calculating of the similarity comprises translating the first-language sentence into the second-language sentence with reference to the translated sentence database if the calculated similarity is higher than a predetermined threshold value.

12. The automatic interpretation method of claim 7, wherein if the calculated similarity is lower than a predetermined threshold value, the translating of the first-language sentence into the second-language sentence is performed not in the calculating of the similarity but in the translating of the first-language sentence into the second-language sentence.
